(19) United States
(12) Patent Application Publication
(10) Pub. No.: US 2006/0123444 A1
(43) Pub. Date: Jun. 8, 2006

(54) Self-diagnostic test for apparatus having an emergency alert function

(75) Inventors: Bruce Wayne Schaffer, Carmel, IN (US); John D Merrell, Noblesville, IN (US)

Correspondence Address: THOMSON LICENSING INC., PATENT OPERATIONS, PO BOX 5312, PRINCETON, NJ, 08543-5312, US

(73) Assignee: Thomson Licensing, Princeton, NJ (US)

(21) Appl. No.: 10/543,940

(22) PCT Filed: Feb. 2, 2004
(86) PCT No.: PCT/US04/02912

§ 371 Date: Aug. 1, 2005

Related U.S. Application Data
(60) Provisional application No. 60/444,411, filed on Feb. 3, 2003.

(51) Int. Cl. H04N 7/10; H04N 7/025

(52) U.S. Cl. 725/33; 725/32

(57) ABSTRACT

An apparatus such as a television signal receiver, radio or other device is capable of performing a self-diagnostic test for an emergency alert function. According to an exemplary embodiment, the apparatus includes a memory operative to store test data associated with the emergency alert function. A decoder is operative to decode the test data to generate test signals. A processor is operative to process the test signals to detect an operating state of the emergency alert function.

The present invention generally relates to apparatuses such as television signal receivers, radios or other apparatuses having an emergency alert function, and more particularly, to a self-diagnostic test for such apparatuses which may be used to ensure that the emergency alert function is operating in a proper manner.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain apparatuses are capable of receiving emergency alert signals provided by sources such as the NWS and NOAA, and provide an emergency alert function using Specific Area Message Encoding (SAME) technology. Apparatuses using SAME technology typically require a user to perform a setup process for the emergency alert function by selecting items such as a frequency channel which is monitored in order to receive emergency alert signals, one or more geographical areas of interest, and one or more types of emergency events which activate the emergency alert function. Once the setup process is complete, the emergency alert function may be activated when incoming emergency alert signals including SAME data indicate the occurrence of an emergency event which corresponds to the geographical area(s) and types of emergency event selected by the user during the setup process. When the emergency alert function is activated, an alert output such as an audio and/or visual message may be provided to alert individuals of the emergency event.

With apparatuses having an emergency alert function using technology such as SAME technology, it is desirable to ensure that the emergency alert function is operating in a proper manner. At present, such apparatuses may test the operation of the emergency alert function by receiving and processing test signals which are generally broadcast on a weekly basis and/or may be provided from external test equipment. In particular, such apparatuses may process the test signals to ensure that the emergency alert function is activated when the test signals indicate the occurrence of an emergency event which corresponds to the geographical area(s) and type of emergency events selected by the user during the setup process.

The aforementioned test processes may be problematic in that operating errors associated with the emergency alert function cannot be detected more than once a week, unless external test equipment is used, or even worse, an emergency event occurs beforehand. Accordingly, there is a need for a technique for testing the operation of the emergency alert function of an apparatus which avoids the foregoing problems, and thereby enables the emergency alert function to be tested without relying on broadcast test signals or the use of external test equipment. The present invention addresses these and other issues.

In accordance with an aspect of the present invention, an apparatus having an emergency alert function is disclosed. According to an exemplary embodiment, the apparatus comprises memory means for storing test data associated with the emergency alert function. Decoding means decode the test data to generate test signals. Processing means process the test signals to detect an operating state of the emergency alert function.

In accordance with another aspect of the present invention, a method for performing a self-diagnostic test for an emergency alert function of an apparatus is disclosed. According to an exemplary embodiment, the method comprises steps of retrieving test data associated with the emergency alert function from a memory within the apparatus, decoding the test data to generate test signals, and processing the test signals to detect an operating state of the emergency alert function.

In accordance with yet another aspect of the present invention, a television signal receiver having an emergency alert function is disclosed. According to an exemplary embodiment, the television signal receiver comprises a memory operative to store test data associated with the emergency alert function. A decoder is operative to decode the test data to generate test signals. A processor is operative to process the test signals to detect an operating state of the emergency alert function.

The above-mentioned and other features and advantages of this invention, and the manner of attaining them, will become more apparent and the invention will be better understood by reference to the following description of embodiments of the invention taken in conjunction with the accompanying drawings, wherein:

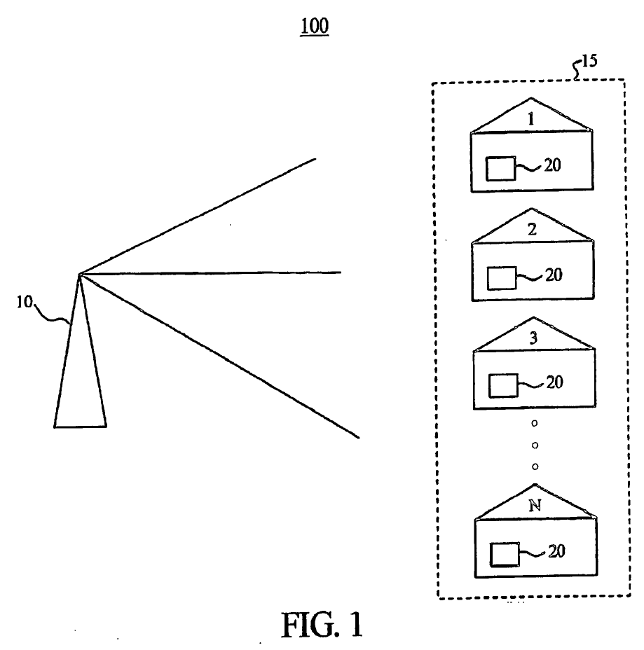

FIG. 1 is an exemplary environment suitable for implementing the present invention;

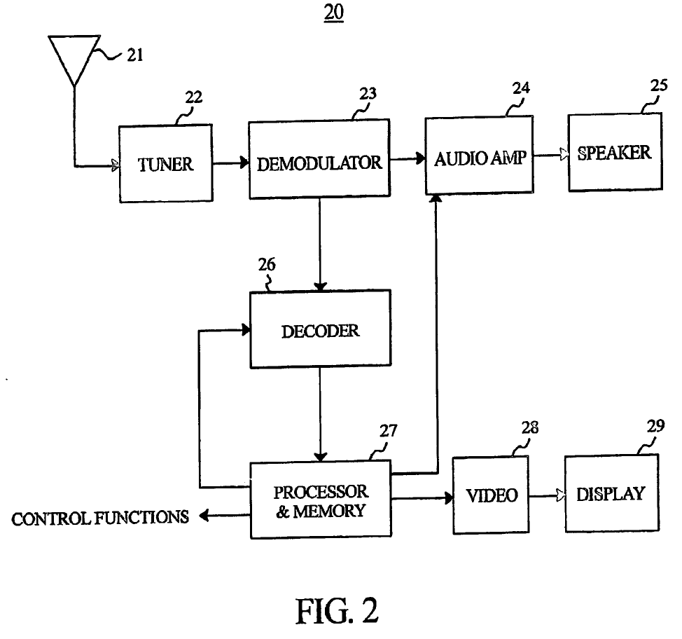

FIG. 2 is a block diagram of a television signal receiver according to an exemplary embodiment of the present invention;

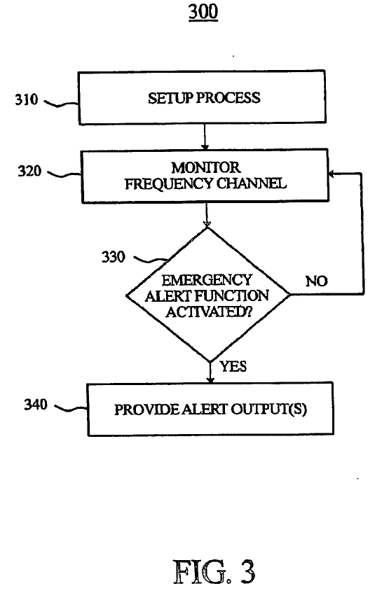

FIG. 3 is a flowchart illustrating exemplary steps for providing an emergency alert function;

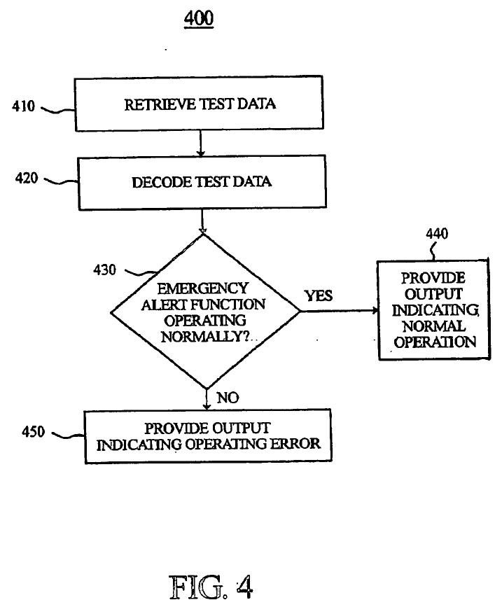

FIG. 4 is a flowchart illustrating steps according to an exemplary embodiment of the present invention;

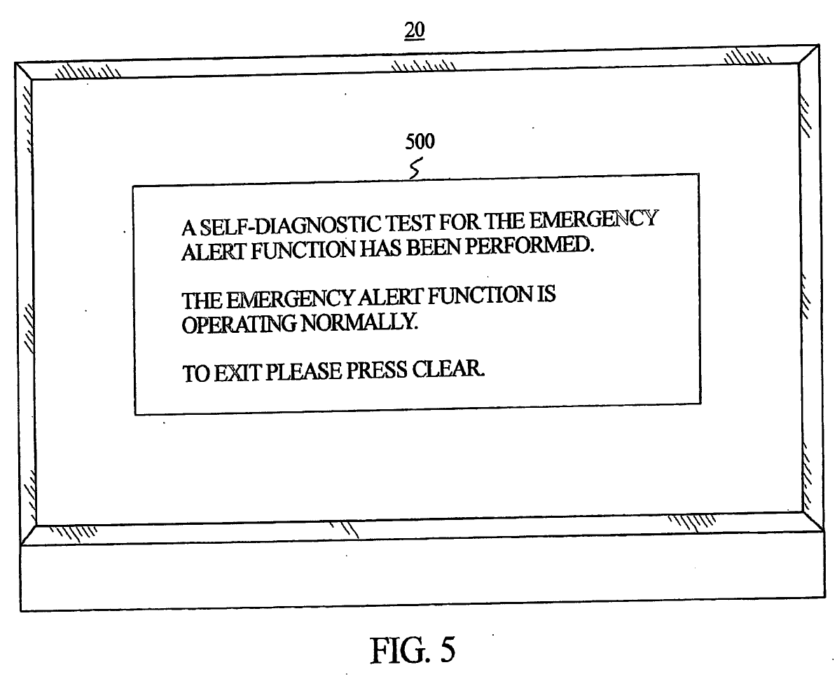

FIG. 5 is an exemplary display suitable for use when practicing the steps of FIG. 4; and

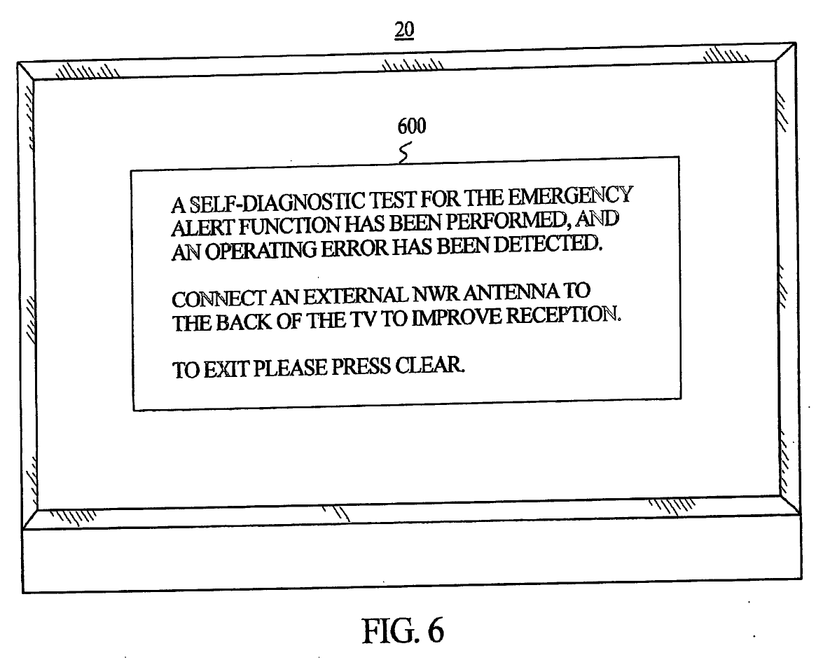

FIG. 6 is another exemplary display suitable for use when practicing the steps of FIG. 4.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as television signal receivers 20.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables, among other things, television signal receiver 20 to receive emergency alert signals and provide one or more alert outputs to notify individuals of an emergency event. For purposes of example, the present invention will be described herein with reference to television signal receiver 20. However, the principles of the present invention may also be used by other apparatuses, such as radios.

According to an exemplary embodiment, signal transmission source 10 transmits signals including audio, video and/or emergency alert signals which may be received by each television signal receiver 20. According to an exemplary embodiment, the emergency alert signals may be provided from an authority such as the NWS, or other authorities such as governmental entities or the like. Signal transmission source 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each television signal receiver 20 may provide one or more alert outputs to thereby notify individuals of the emergency event. Signal transmission source 10 may transmit signals to television signal receivers 20 via any wired or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements associated with television signal receiver 20 such as certain control signals, power signals and/or other elements may not be shown in FIG. 2.

Signal receiving element 21 is operative to receive signals including audio, video and/or emergency alert signals from signal sources, such as signal transmission source 10 in FIG. 1. According to an exemplary embodiment, received audio signals may include digitally encoded emergency alert signals. According to another exemplary embodiment, emergency alert signals may be received as separate data packets in a digital transmission system. Signal receiving element 21 may be embodied as any signal receiving element such as an antenna, input terminal or other element.

Tuner 22 is operative to tune signals including audio, video and/or emergency alert signals. According to an exemplary embodiment, tuner 22 may be capable of tuning audio signals on at least the following designated NWS frequencies: 162.400 MHz, 162.425 MHz, 162.450 MHz, 162.475 MHz, 162.500 MHz, 162.525 MHz and 162.550 MHz. As previously indicated herein, such audio signals may include digitally encoded emergency alert signals. Tuner 22 may also tune other frequency channels including those used in terrestrial, cable, satellite and/or other transmissions.

Demodulator 23 is operative to demodulate signals provided from tuner 22, and may demodulate signals in analog and/or digital transmission formats. According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to one or more control signals provided from processor 27. Speaker 25 is operative to aurally output the amplified audio signals provided from audio amplifier 24.

Decoder 26 is operative to decode signals including audio, video and/or emergency alert signals. According to an exemplary embodiment, decoder 26 decodes audio signals to thereby extract digitally encoded frequency shift keyed (FSK) signals, which represent emergency alert signals indicating an emergency event. Decoder 27 is also operative to decode digital data including test data associated with the emergency alert function. Decoder 27 may also perform other decoding functions, such as decoding data which represents emergency alert signals included in the vertical blanking interval (VBI) of an analog television signal.

According to an exemplary embodiment, the emergency alert signals include data comprising SAME data associated with the emergency event. SAME data comprises a digital code representing information such as the specific geographical area affected by the emergency event, the type of emergency event (e.g., tornado watch, radiological hazard warning, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of television signal receiver 20 allows a user to select items such as an applicable geographical area(s), and type(s) of emergency events (e.g., tornado watch, radiological hazard warning, civil emergency, etc.) which activate the emergency alert function.

When the emergency alert function of television signal receiver 20 is activated, processor 27 outputs one or more control signals which enable various operations. According to an exemplary embodiment, such control signals enable one or more alert outputs (e.g., aural and/or visual) to thereby notify individuals of the emergency event. Such control signals may also enable other operations of television signal receiver 20, such as causing it to be switched from an off/standby mode to an on mode.

Processor 27 is also operative to enable other operations associated with the emergency alert function of television signal receiver 20. According to the present invention, processor 27 is operative to enable a self-diagnostic test using test data stored in memory 27 to thereby detect any operational errors associated with the emergency alert function. In this manner, the emergency alert function may be tested without relying on broadcast test signals or the use of external test equipment. Further details regarding this aspect of the present invention will be provided later herein.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays.

Display 29 is operative to provide visual displays. According to an exemplary embodiment, display 29 may provide visual displays including the aforementioned messages that provide details regarding emergency events. Display 29 may also include a viewable display panel having one or more indicator elements such as light emitting diodes (LEDs), liquid crystal display (LCD) elements, liquid quartz display (LQD) elements, and/or other elements. Such indicator elements may include highlighted indicators, such as monochrome and/or colored indicators, plasma display indicators, and/or conventional lights used as consumer electronic product indicators, and may for example reside apart from television signal receiver 20, such as on a portable (e.g., non-tethered) lighted panel designed for a wall and/or desk display. This may also allow various LED, LCD, LQD, plasma and/or cathode ray tube (CRT) devices to incorporate indicator elements for the emergency alert function as the total visual data field or a portion thereof. For example, the indicator elements may be highlighted as a portion of the visual data being displayed on an LCD panel playing recorded video content, such as content from a digital versatile disk (DVD) or the like.

Turning now to FIG. 3, a flowchart 300 illustrating exemplary steps for providing an emergency alert function is shown. For purposes of example and explanation, the steps of FIG. 3 will be described with reference to television signal receiver 20 of FIG. 2. The steps of FIG. 3 are merely exemplary, and are not intended to limit the present invention in any manner.

At step 310, a setup process for the emergency alert function of television signal receiver 20 is performed. According to an exemplary embodiment, a user performs this setup process by providing inputs to television signal receiver 20 (e.g., using a remote control device not shown) responsive to an on-screen menu displayed via display 29. Such an on-screen menu may for example be part of an electronic program guide (EPG) function of television signal receiver 20. According to an exemplary embodiment, the user may select at least the following items during the setup process at step 310:

A. Enable/Disable—The user may select whether to enable or disable the emergency alert function.

B. Frequency Channel—The user may select the frequency channel which is monitored in order to receive emergency alert signals. For example, the user may select a frequency such as one of the following NWS transmission frequencies: 162.400 MHz, 162.425 MHz, 162.450 MHz, 162.475 MHz, 162.500 MHz, 162.525 MHz and 162.550 MHz. A frequency channel may be manually selected by the user, or may be selected using an auto-tune mode which automatically tunes all of the frequency channels associated with the emergency alert function to thereby identify one or more frequency channels that provide the highest signal strength.

C. Geographical Areas—The user may select one or more geographical areas of interest. For example, the user may select a particular continent, country, region, state, area code, zip code, city, county, municipality, subdivision, and/or other definable geographical area. Such geographical area(s) may be represented by location codes, such as Federal Information Processing Standard (FIPS) location codes.

D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.

E. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune television signal receiver 20 to a specific channel. The user may also for example select to aurally output a warning tone (e.g., chime, siren, etc.) and/or an audio message (e.g., NWS audio message), and the desired volume of each. Other types of alert outputs may also be provided according to the present invention.

According to the present invention, other menu selections may also be provided at step 310 and/or some of the menu selections described above may be omitted. Data corresponding to the user's selections during the setup process of step 310 is stored in memory 27.

At step 320, television signal receiver 20 monitors the frequency selected by the user during the setup process of step 310 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content.

At step 330, a determination is made as to whether the emergency alert function of television signal receiver 20 is activated. According to an exemplary embodiment, processor 27 makes this determination by comparing data included in the incoming emergency alert signals to data stored in memory 27. As previously indicated herein, the emergency alert signals may include data such as SAME data which represents information including the type of emergency event (e.g., tornado watch, radiological hazard warning, civil emergency, etc.) and the specific geographical area(s) affected by the emergency event. According to an exemplary embodiment, processor 27 compares this SAME data to corresponding user setup data (i.e., items C and D of step 310) stored in memory 27 to thereby determine whether the emergency alert function is activated. In this manner, the emergency alert function of television signal receiver 20 is activated when the emergency event indicated by the emergency alert signals corresponds to: (1) the geographical area(s) selected by the user for item C of step 310 and (2) the event type(s) selected by the user for item D of step 310.

If the determination at step 330 is negative, process flow loops back to step 320 where tuner 22 continues to monitor the selected frequency channel. Alternatively, if the determination at step 330 is positive, process flow advances to step 340 where television signal receiver 20 provides one or more alert outputs to thereby notify individuals of the emergency event.

According to an exemplary embodiment, processor 27 enables the one or more alert outputs at step 340 in accordance with the user's selections during the setup process of step 310 (i.e., item E), and such alert outputs may be aural and/or visual in nature. For example, aural outputs such as a warning tone and/or an NWS audio message may be provided at step 340 via speaker 25, and the volume of such aural outputs may be controlled in accordance with the volume level set by the user during the setup process of step 310. Visual outputs may also be provided at step 340 via display 29 to notify individuals of the emergency event. According to an exemplary embodiment, an auxiliary information display such as an NWS text message (e.g., as a closed caption display) and/or a video output from a specific channel may be provided at step 340 via display 29 under the control of processor 27.

According to another exemplary embodiment, the alert output(s) provided at step 340 may be based on the severity or alert level of the particular emergency event. For example, emergency events may be classified in one of three different alert level categories, such as statement, watch, and warning. With such a classification scheme, the alert output for an emergency event at a level 1 or statement level may be provided by an unobtrusive notification means such as a blinking LED since it is the least severe type of emergency event; The alert output for an emergency event at a level 2 or watch level may have some type of audio component (e.g., radio message). The alert output for an emergency event at a level 3 or warning level may be provided by a siren or other type of alarm since it is the most severe type of emergency event. Other types of aural and/or visual alert outputs than those expressly described herein may also be provided according to the present invention.

Turning now to FIG. 4, a flowchart 400 illustrating steps according to an exemplary embodiment of the present invention is shown. In particular, the steps of FIG. 4 illustrate how a self-diagnostic test for the emergency alert function may be performed according to the present invention. For purposes of example and explanation, the steps of FIG. 4 will also be described with reference to television signal receiver 20 of FIG. 2. The steps of FIG. 4 are merely exemplary, and are not intended to limit the present invention in any manner.

At step 410, processor 27 retrieves test data from memory 27 and provides the test data to decoder 26. According to an exemplary embodiment, the test data may represent SAME data previously received by television signal receiver 20 during an emergency event. According to another exemplary embodiment, the test data may represent predetermined SAME data which is used exclusively for the purpose of conducting the self-diagnostic test of the emergency alert function. As previously indicated herein, SAME data includes information indicating a type of emergency event (e.g., tornado watch, radiological hazard warning, civil emergency, etc.) and the specific geographical area(s) affected by the emergency event.

At step 420, decoder 26 decodes the test data and provides the resultant decoded signals to processor 27. At step 430, processor 27 processes the decoded signals to determine whether the emergency alert function of television signal receiver 20 is operating normally (i.e., no operating errors). According to an exemplary embodiment, processor 27 is programmed to make the determination at step 430 by detecting whether television signal receiver 20 responds to the test signals in a prescribed manner. For example, processor 27 may determine at step 430 whether television signal receiver 20 responds to the test signals in a manner consistent with the user setup data designated at step 310 of FIG. 3.

If the determination at step 430 is positive, process flow advances to step 440 where an output is provided to indicate that the emergency alert function is operating normally. According to an exemplary embodiment, the output provided at step 440 may be aural and/or visual in nature. FIG. 5 shows an example of a visual output message 500 which may be provided at step 440. Other types of visual outputs, such as ones using the previously described indicator elements of display 29, may also be provided at step 440 according to the present invention. According to a variation of the present invention, the output of step 440 may be omitted since the emergency alert function is operating normally. The option of whether to provide an output at step 440 (and if so the type of output) may for example be decided by the user during the setup process for the emergency alert function at step 310 of FIG. 3.

If the determination at step 430 is negative, process flow advances to step 450 where an output is provided to indicate that an operating error of the emergency alert function has been detected. According to an exemplary embodiment, the output provided at step 450 may be aural and/or visual in nature. FIG. 6 shows an example of a visual output message 600 which may be provided at step 450. As indicated in FIG. 6, exemplary output message 600 may indicate a corrective action to be taken to improve the operating state of the emergency alert function, such as instructing the user to connect an external antenna to television signal receiver 20 to improve signal reception. Other types of visual outputs, such as ones using the previously described indicator elements of display 29, may also be provided at step 450 according to the present invention.

The self-diagnostic test represented in FIG. 4 may for example be performed responsive to a user input (e.g., “test now”) to television signal receiver 20, and/or may be automatically performed on a periodic basis (e.g., daily, every other day, etc.). When performed automatically, the frequency at which the self-diagnostic test is performed may for example be decided by the user during the setup process for the emergency alert function at step 310 of FIG. 3. Moreover, the self-diagnostic test represented in FIG. 4 may be used in conjunction with the previously mentioned weekly broadcast tests and thereby provide an additional means by which to ensure that the emergency alert function is operating properly.

As described herein, the present invention provides a self-diagnostic test for an emergency alert function of an apparatus which enables the emergency alert function to be tested without relying on broadcast test signals or the use of external test equipment. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), DVD players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus having an emergency alert function, comprising:
memory means for storing test data associated with said emergency alert function;
decoding means for decoding said test data to generate test signals; and
processing means for processing said test signals to detect an operating state of said emergency alert function.

2. The apparatus of claim 1, further comprising output means for providing an output responsive to said processing means detecting said operating state.

3. The apparatus of claim 2, wherein:
said operating state includes an operating error; and
said output indicates a corrective action.

4. The apparatus of claim 1, wherein said test signals indicate a geographical area.

5. The apparatus of claim 4, wherein said geographical area is represented by a FIPS code.

6. The apparatus of claim 1, wherein said test signals indicate an emergency event.

7. A method for performing a self-diagnostic test for an emergency alert function of an apparatus, comprising:
retrieving test data associated with said emergency alert function from a memory within said apparatus;
decoding said test data to generate test signals; and
processing said test signals to detect an operating state of said emergency alert function.

8. The method of claim 1, further comprised of providing an output responsive to said detection of said operating state.

9. The method of claim 8, wherein:
said operating state includes an operating error; and
said output indicates a corrective action.

10. The method of claim 7, wherein said test signals indicate a geographical area.

11. The method of claim 10, wherein said geographical area is represented by a FIPS code.

12. The method of claim 7, wherein said test signals indicate an emergency event.

13. A television signal receiver having an emergency alert function, comprising:
a memory operative to store test data associated with said emergency alert function;
a decoder operative to decode said test data to generate test signals; and
a processor operative to process said test signals to detect an operating state of said emergency alert function.

14. The television signal receiver of claim 13, further comprising an output device operative to provide an output responsive to said processor detecting said operating state.

15. The television signal receiver of claim 14, wherein:
said operating state includes an operating error; and
said output indicates a corrective action.

16. The television signal receiver of claim 13, wherein said test signals indicate a geographical area.

17. The television signal receiver of claim 16, wherein said geographical area is represented by a FIPS code.

18. The television signal receiver of claim 13, wherein said test signals indicate an emergency event.
